(19) United States
(12) Patent Application Publication
(10) Pub. No.: US 2010/0230177 A1
(43) Pub. Date: Sep. 16, 2010

(54) EARTH-BORING TOOLS WITH THERMALLY CONDUCTIVE REGIONS AND RELATED METHODS

(75) Inventor: Redd H. Smith, The Woodlands, TX (US)

Correspondence Address: TRASKBRITT, P.C., P.O. BOX 2550, SALT LAKE CITY, UT, 84110, US

(73) Assignee: BAKER HUGHES INCORPORATED, Houston, TX (US)

(21) Appl. No.: 12/401,093

(22) Filed: Mar. 10, 2009

(51) Int. Cl. E21B 10/573; E21B 10/42; E21B 10/55; C09K 3/14

(52) U.S. Cl. 175/433; 51/309

(57) ABSTRACT

Earth-boring tools comprising bodies with one or more thermally conductive insert support regions and one or more inserts secured to the one or more insert support regions are disclosed. The inserts may each comprise an insert body, which may be secured to the one or more insert support regions of the body. In some embodiments, one or more insert support regions of the body may have a thermal conductivity similar to the thermal conductivity of the insert body of the one or more inserts. In additional embodiments, one or more insert support regions of the body may have a thermal conductivity that is greater than the thermal conductivity of the insert body of the one or more inserts. In further embodiments, methods of forming earth-boring tools comprising bodies with one or more thermally conductive insert support regions are disclosed.

### CROSS-REFERENCE TO RELATED APPLICATIONS

This application is related to U.S. patent application Ser. No. 11/272,439, filed on Nov. 11, 2005, pending, in the name of Smith et al., assigned to the assignee of the present application. This application is also related to U.S. patent application Ser. No. 12/401,030, filed on Mar. 10, 2009, pending, in the name of Redd H. Smith, and entitled “EARTH-BORING TOOLS WITH STIFF INSERT SUPPORT REGIONS AND RELATED METHODS,” assigned to the assignee of the present application. The disclosure of each of the foregoing applications is hereby incorporated herein in its entirety by reference.

### TECHNICAL FIELD

The present invention generally relates to earth-boring rotary tools, and to methods of manufacturing such earth-boring rotary tools. More particularly, embodiments of the present invention relate generally to earth-boring rotary drill bits that include insert support regions having a thermal conductivity that is somewhat similar to a thermal conductivity of bodies of inserts secured thereto, including without limitation a thermal conductivity that exceeds the thermal conductivity of the bodies, and to methods of manufacturing such earth-boring rotary drill bits.

### BACKGROUND

One configuration of a rotary drill bit is a fixed-cutter bit (often referred to as a “drag” bit), which typically includes a plurality of cutting elements secured to a face region of a bit body. Generally, the cutting elements of a fixed-cutter type drill bit are inserts that have either a disk shape or a substantially cylindrical shape. A hard, superabrasive material, such as mutually bonded particles of polycrystalline diamond, may be provided on a substantially circular end surface of each insert to provide a cutting surface. Such inserts are often referred to as “polycrystalline diamond compact” (PDC) cutters. The inserts are fabricated separately from the bit body and secured within pockets formed in the outer surface of the bit body. A bonding material such as an adhesive or, more typically, a braze alloy may be used to secure the inserts to the bit body. The fixed-cutter drill bit may be placed in a bore hole such that the cutting elements are adjacent the earth formation to be drilled. As the drill bit is rotated, the cutting elements scrape across and shear away the surface of the underlying formation.

As the inserts for earth-boring rotary drill bits, such as PDC cutters, interact directly with a formation, scraping and shearing away the rock and earth to form a bore hole, the inserts may experience substantial stress, abrasion and frictionally induced heat. As the inserts wear away due to abrasion, become dislodged from the bit body, and/or fail under heat and stresses generated during drilling, the earth-boring tool may become less effective and/or fail.

In view of the above, it would be advantageous to provide improved earth-boring tools. For example, it would be advantageous to provide earth-boring tools with improved thermal properties. Additionally, it would be advantageous to provide earth-boring tools with improved insert durability and an improved working life.

### BRIEF SUMMARY

In some embodiments, an earth-boring tool comprises a body comprising one or more insert support regions and one or more inserts. The inserts each comprise an insert body, which may be secured to the one or more insert support regions of the body. Furthermore, each insert support region of the body may have a thermal conductivity within a range of about 50% to about 150% of a thermal conductivity of an insert body secured thereto.

In additional embodiments, an earth-boring tool comprises one or more inserts, each secured to an insert support region of a body of the earth-boring tool. Each insert may comprise a particle-matrix composite insert body with a thermal conductivity greater than about 100 W/mK. Additionally, each insert support region formed in the body may have a thermal conductivity within a range of about 50% to about 150% of a thermal conductivity of an insert body of an insert secured thereto.

In further embodiments, a method of forming an earth-boring tool comprises forming a body having at least one insert support region with a thermal conductivity within a range of about 50% to about 150% of a thermal conductivity of an insert body of at least one insert by sintering a powder mixture and securing the insert body of each insert to the one or more support regions of the body.

In additional embodiments, an earth-boring tool comprises one or more inserts having an insert body secured to one or more insert support regions of a body of the earth-boring tool. Furthermore, each insert support region may have a thermal conductivity that is greater than the thermal conductivity of the insert body of an insert secured thereto.

In yet additional embodiments, an earth-boring tool comprises a body having at least one insert support region having a thermal conductivity greater than a thermal conductivity of a majority of the body.

The features, advantages, and additional aspects and embodiments of the present invention will be apparent to those skilled in the art from a consideration of the following detailed description considered in combination with the accompanying drawings.

### BRIEF DESCRIPTION OF THE SEVERAL VIEWS OF THE DRAWINGS

FIG. 1 shows a partial cross-sectional side view of an earth-boring rotary drill bit according to an embodiment of the present invention.

FIG. 2 shows a graph of a relationship between density and material composition of particle-matrix composite bodies and thermal conductivity of the particle-matrix composite bodies.

FIGS. 3A-3E illustrate a method of forming a body of the earth-boring rotary drill bit shown in FIG. 1.

FIG. 4A is a lateral cross-sectional detail view of an insert and an insert support region of the earth-boring rotary drill bit shown in FIG. 1.

FIG. 4B is a longitudinal cross-sectional detail view of the insert and the insert support region shown in FIG. 4A.

### DETAILED DESCRIPTION

The illustrations presented herein are not meant to be actual views of any particular material, apparatus, system, or method, but are merely idealized representations which are employed to describe the present invention. Additionally, elements common between figures may retain the same numerical designation.

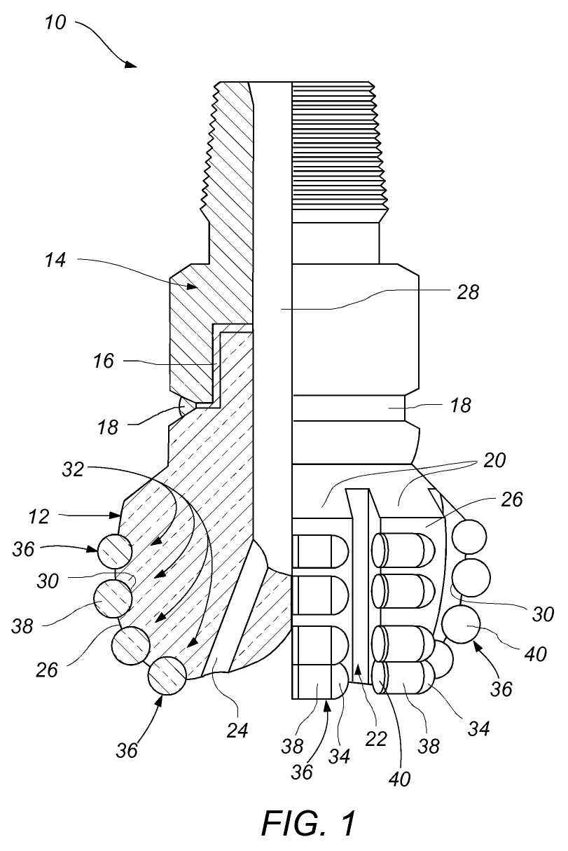

An earth-boring rotary drill bit 10 is shown in FIG. 1. The drill bit 10 includes a bit body 12 that may be substantially formed from, and comprises, a particle-matrix composite material. The drill bit 10 also may include a shank, such as a steel shank 14, attached, such as by a braze 16 and/or a weld 18, to the bit body 12.

The bit body 12 may include blades 20, which are separated by junk slots 22. Internal fluid passageways 24 may extend between the face 26 of the bit body 12 and a longitudinal bore 28, which may extend through the shank 14 and partially through the bit body 12.

The bit body 12 may include one or more pockets 30 formed in insert support regions 32 of the bit body 12, and each pocket 30 may be partially defined by a buttress 34. An insert 36, such as a PDC cutter, may be positioned within each pocket 30. Each insert 36 may comprise an insert body 38 with a relatively hard material, such as a PDC diamond table 40, formed thereon, and the body 38 of the cutter 36 may be secured to an insert support region 32 of the bit body 12. In additional embodiments, the inserts 36 may be formed from an abrasive, wear-resistant material such as, for example, cemented tungsten carbide that does not include a PDC diamond table 40.

Much time and effort has been spent on improving the material properties of inserts for earth-boring tools in an attempt to strengthen and harden the inserts to minimize abrasive wear and stress fracturing of the inserts and improve the working life of the inserts. However, the inventor of the present invention has discovered that the material properties of insert support regions of a bit body are also significant and may have an unexpected effect on the working life of the inserts. Specifically, an insert support region that has a thermal conductivity that is at least similar to, including without limitation greater than, the thermal conductivity of the insert that it supports may significantly improve the working life of the insert, when compared to the working life of the same or similar insert supported by a conventional insert pocket having a thermal conductivity that is significantly less than the thermal conductivity of the insert. The term “thermal conductivity” or “λ,” as used herein, is defined as the product of the measured quantities of a materials thermal diffusivity (a), such as measured by the laser flash method (as defined by the ASTM international test standard ASTM E 1461), a materials specific heat (cₚ), such as measured by a differential scanning calorimeter with sapphire as the reference material (as defined by the ASTM international test standard ASTM E 1269), and a materials bulk density (d), each measured at 295 degrees Kelvin (K), i.e. λ=a cₚ d.

In view of this, in some embodiments, insert support regions 32 of the bit body 12 may have a thermal conductivity that is similar to the thermal conductivity of the insert body 38 of each insert 36. For example, in some embodiments, one or more insert support regions 32 of the bit body 12 may have a thermal conductivity within a range of about 50% to about 150% of the thermal conductivity of the insert body 38 of one or more inserts 36. In additional embodiments, one or more insert support regions 32 of the bit body 12 may have a thermal conductivity within a range of about 75% to about 125% of the thermal conductivity of the insert body 38 of one or more inserts 36. In further embodiments, one or more insert support regions 32 of the bit body 12 may have a thermal conductivity within a range of about 85% to about 115% of the thermal conductivity of the insert body 38 of one or more inserts 36. In additional embodiments, one or more insert support regions 32 of the bit body 12 may have a thermal conductivity within a range of about 95% to about 105% of the thermal conductivity of the insert body 38 of one or more inserts 36. In yet further embodiments, one or more insert support regions 32 of the bit body 12 may have a thermal conductivity that is substantially the same as thermal conductivity of the insert body 38 of one or more inserts 36.

In additional embodiments, one or more insert support regions 32 of the bit body 12 may have a thermal conductivity that is higher than the thermal conductivity of the insert body 38 of one or more inserts 36.

In one embodiment, the bit body 12 may include distinct insert support regions 32, each of which may comprise a particle-matrix composite material that may have a material composition different than that of another region of the bit body 12. A discrete boundary may be identifiable between the insert support regions 32 of the bit body 12 and other regions of the bit body 12. As used herein, the term “material composition” means the chemical composition and microstructure of a material. In other words, materials having the same chemical composition but a different microstructure are considered as having different material compositions.

In additional embodiments, a material composition gradient may be provided within the bit body 12 to provide a drill bit 10 having a plurality of insert support regions 32, each having a material composition different than the material composition of another region of the bit body 12, but lacking any identifiable boundaries between the various regions. In this manner, the physical properties and characteristics of the insert support regions 32 within the bit body 12 may be tailored to a selected thermal conductivity, while other regions may have material compositions that are selected or tailored to exhibit any desired particular physical property or characteristic. In yet additional embodiments, the bit body 12 may be formed from a single material composition, and the insert support regions 32 may be indistinguishable from the majority of the bit body 12.

In some embodiments, an earth-boring tool may comprise a body having at least one insert support region having a thermal conductivity greater than a thermal conductivity of a majority of the body. For example, the insert support regions 32 of the bit body 12 may be formed of a different material composition than a majority of the bit body 12.

In additional embodiments, an earth-boring tool may comprise a body having at least one insert support region having a thermal conductivity that is substantially the same as a thermal conductivity of a majority of the body. For example, the insert support regions 32 of the bit body 12 may comprise substantially the same material composition as the material composition of the majority of the bit body 12.

The particle-matrix composite material of the bit body 12 may include a plurality of hard particles randomly dispersed throughout a matrix material. The hard particles may comprise diamond or ceramic materials such as carbides, nitrides, oxides, and borides (including boron carbide (B₄C)). More specifically, the hard particles may comprise carbides and borides made from elements such as W, Ti, Mo, Nb, V, Hf, Ta, Cr, Zr, Al, and Si. By way of example and not limitation, materials that may be used to form hard particles include tungsten carbide (WC), titanium carbide (TiC), tantalum carbide (TaC), titanium diboride (TiB₂), chromium carbides, titanium nitride (TiN), aluminum oxide (Al₂O₃), aluminum nitride (AlN), and silicon carbide (SiC). Furthermore, combinations of different hard particles may be used to tailor the physical properties and characteristics of the particle-matrix composite material. The hard particles may be formed using known techniques. Most suitable materials for hard particles are commercially available and the formation of the remainder is known within the art.

The matrix material of the particle-matrix composite material may include, for example, cobalt-based, iron-based, nickel-based, iron- and nickel-based, cobalt and nickel-based, iron- and cobalt-based, aluminum-based, copper-based, magnesium-based, and titanium-based alloys. The matrix material may also be selected from commercially pure elements such as cobalt, aluminum, copper, magnesium, titanium, iron, and nickel. By way of example and not limitation, the matrix material may include carbon steel, alloy steel, stainless steel, tool steel, Hadfield manganese steel, nickel or cobalt superalloy material, and low thermal expansion iron- or nickel-based alloys such as INVAR®. As used herein, the term “superalloy” refers to aniron-, nickel-, and cobalt-based alloys having at least 12% chromium by weight. Additional examples of alloys that may be used as matrix material include austenitic steels, nickel-based superalloys such as INCONEL® 625M or Rene 95, and INVAR® type alloys having a coefficient of thermal expansion that closely matches that of the hard particles used in the particular particle-matrix composite material. More closely matching the coefficient of thermal expansion of matrix material with that of the hard particles offers advantages such as reducing problems associated with residual stresses and thermal fatigue. Another example of a suitable matrix material is a Hadfield austenitic manganese steel (Fe with approximately 12% Mn by weight and 1.1% C by weight).

In one embodiment, the bit body 12 may be comprised of a particle-matrix composite material that includes a plurality of −400 ASTM (American Society for Testing and Materials) mesh tungsten carbide particles. For example, the tungsten carbide particles may substantially comprise tungsten carbide. As used herein, the phrase “−400 ASTM mesh particles” means particles that pass through an ASTM No. 400 mesh screen as defined in ASTM specification E11-04 entitled “Standard Specification for Wire Cloth and Sieves for Testing Purposes.” Such tungsten carbide particles may have a diameter of less than about 38 microns. The matrix material may include a metal alloy comprising cobalt and nickel. For example, the matrix material may include a metal alloy comprising about 50% cobalt by weight and about 50% nickel by weight.

In another embodiment, the bit body 12 may be comprised of a particle-matrix composite material that includes a plurality of −635 ASTM mesh tungsten carbide particles. As used herein, the phrase “−635 ASTM mesh particles” means particles that pass through an ASTM No. 635 mesh screen as defined in ASTM specification E11-04 entitled “Standard Specification for Wire Cloth and Sieves for Testing Purposes.” Such tungsten carbide particles may have a diameter of less than about 20 microns. The matrix material may include a cobalt-based metal alloy comprising substantially commercially pure cobalt. For example, the matrix material may include greater than about 98% cobalt by weight.

The thermal conductivity of each insert support region 32 of a particle-matrix composite bit body 12 may vary by the materials chosen, such as the composition of the matrix material and/or hard particles. Also, impurities in the bit body 12 and the final porosity or density of the bit body 12 may affect the thermal conductivity of the bit body 12. Additionally, the thermal conductivity of each insert support region 32 of a bit body 12 formed from such particle-matrix composite materials may vary according to the ratio of hard particles, such as tungsten carbide particles, to the matrix material, such as cobalt and/or nickel, in each insert support region 32 of the bit body 12.

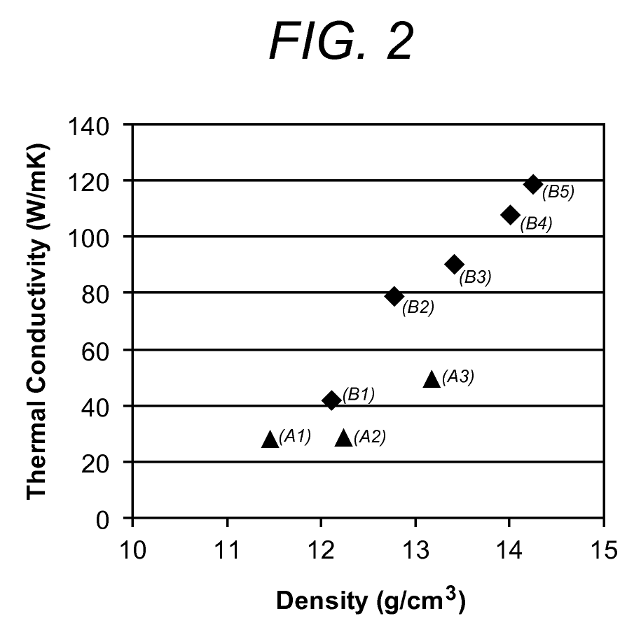

FIG. 2 shows the thermal conductivities of several particle-matrix composite material samples in comparison to their respective density. The thermal conductivity is displayed in Watts per meter Kelvin (W/mK), and the density is displayed in grams per cubic centimeter (g/cm³). The samples include particle-matrix composite material samples B1-B5, formed by powder compaction and sintering methods, such as described herein, and particle-matrix composite material samples A1-A3, formed by conventional infiltration methods utilizing molten copper-based alloys. Sample B1 includes 35% by weight cobalt-nickel matrix material, sample B2 includes 30% by weight cobalt-nickel matrix material, sample B3 includes 20% by weight cobalt matrix material, sample B4 includes 15% by weight cobalt-nickel matrix material, and sample B5 includes 13% by weight cobalt matrix material. The remaining weight percentage of each of samples B1-B5 is tungsten carbide hard particles.

As may be observed by samples B1-B5 in FIG. 2, as the weight percentage matrix material decreases, and thus the weight percentage tungsten carbide hard particles increases, the density of the particle-matrix composite material may increase. Additionally, as the weight percentage tungsten carbide and density of the particle-matrix composite material increases, the thermal conductivity of the particle-matrix composite material may also increase.

Additionally, it may be observed in FIG. 2 that sample B1 has a higher thermal conductivity than sample A2 and sample B2 has a higher thermal conductivity than sample A3, although sample A2 is more dense than sample B1 and sample A3 is more dense than sample B2, due to an increased ratio of tungsten carbide hard particles to matrix material. The relatively low thermal conductivity of samples A1-A3, relative to samples B1-B5, may be due to the inherent properties imparted by the conventional infiltration methods used to form samples A1-A3. Conventional infiltration methods may result in impurities, trapped gas pockets, and other imperfections in the matrix of the particle-matrix composite material. These imperfections may result in reduced thermal conductivity in the material, as imperfections, such as gas pockets, may have relatively poor thermal conductivity and impede the transfer of heat through the material. In view of this, although particle-matrix composite materials formed using conventional infiltration methods may be formed of a matrix material that is generally considered to be a relatively good thermal conductor, for example, samples A1-A3 include a copper-based matrix material, and may include a relatively high weight percentage of tungsten carbide hard particles, the inclusion of imperfections in the matrix resulting from the infiltration process may result in particle-matrix composite materials with relatively low thermal conductivity.

In view of this, the bit body 12 may be formed using a sintering method as described herein, and the material composition of each insert support region 32 of the bit body 12 may be selected so that the thermal conductivity of each insert support region 32 is similar to, and/or exceeds, the thermal conductivity of the insert body 38 of a selected insert 36. For example, a material composition may be selected that may form insert support regions 32 having a thermal conductivity greater than about 60 W/mK. In an additional embodiment, a material composition may be selected that may form insert support regions 32 having a thermal conductivity greater than about 80 W/mK. In further embodiments, a material composition may be selected that may form insert support regions 32 having a thermal conductivity greater than about 100 W/mK. In yet additional embodiments, a material composition may be selected that may form insert support regions 32 having a thermal conductivity greater than about 110 W/mK.

Bit bodies 12, such as described in embodiments herein, having one or more insert support regions 32 that have a thermal conductivity that is similar to, such term including without limitation greater than, the thermal conductivity of an insert body 38 of an insert 36 secured thereto may be formed from particle-matrix composite materials using powder compaction, machining, and sintering methods similar to those described in U.S. patent application Ser. No. 11/272,439, the disclosure of which is previously incorporated by reference herein.

Such sintering methods of forming particle-matrix composite bit bodies, as described herein, may produce a bit body 12 that may have a more accurately defined and predictable material distribution, increased density, fewer imperfections and a greater thermal conductivity than a bit body formed from similar materials by different methods, such as conventional infiltration methods.

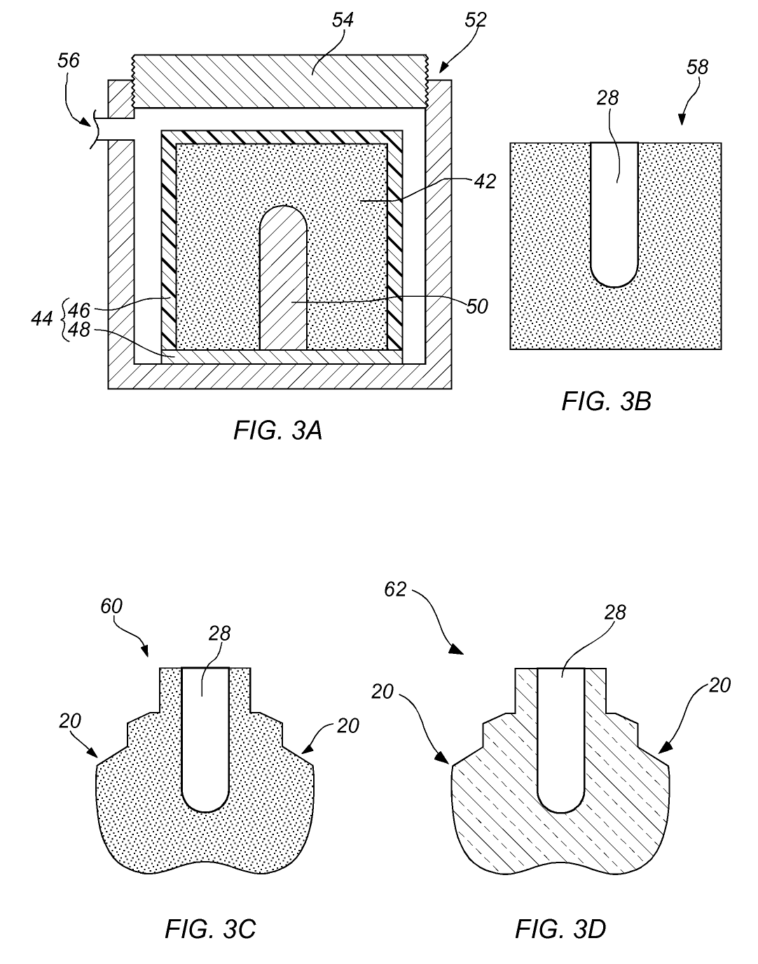

FIGS. 3A-3E illustrate a method of forming the bit body 12 (FIG. 1), which is substantially formed from and comprises a particle-matrix composite material with improved thermal properties. The method generally includes providing a powder mixture, pressing the powder mixture to form a green body, and at least partially sintering the powder mixture.

Referring to FIG. 3A, a powder mixture 42 may be pressed with substantially isostatic pressure within a mold or container 44. The powder mixture 42 may include a plurality of the previously described hard particles and a plurality of particles comprising a matrix material, as also previously described herein. Optionally, the powder mixture 42 may further include additives commonly used when pressing powder mixtures such as, for example, binders for providing lubrication during pressing and for providing structural strength to the pressed powder component, plasticizers for making the binder more pliable, and lubricants or compaction aids for reducing inter-particle friction.

In some embodiments the powder mixture 42 may have a substantially evenly distributed material composition. For example, an evenly distributed material composition may be used to form a bit body 12 having substantially uniform material properties throughout the bit body 12, including the insert support regions 32 (FIG. 1) of the bit body 12.

In additional embodiments, the powder mixture 42 may include regions with differing material compositions. For example, regions that may form insert support regions 32 of the bit body 12 may comprise a higher weight proportion of hard particles to powdered matrix material, which may result in insert support regions 32 with greater thermal conductivity than other regions of the bit body 12.

The container 44 may include a fluid-tight deformable member 46. For example, the fluid-tight deformable member 46 may be a substantially cylindrical bag comprising a deformable polymer material. The container 44 may further include a sealing plate 48, which may be substantially rigid. The deformable member 46 may be formed from, for example, an elastomer such as rubber, neoprene, silicone, or polyurethane. The deformable member 46 may be filled with the powder mixture 42 and vibrated to provide a uniform compaction of the powder mixture 42 within the deformable member 46. At least one displacement 50 may be provided within the deformable member 46 for defining features of the bit body 12 such as, for example, the longitudinal bore 28 (FIG. 1). Additionally, the displacement 50 may not be used and the longitudinal bore 28 may be formed using a conventional machining process during subsequent processes. The sealing plate 48 then may be attached or bonded to the deformable member 46 providing a fluid-tight seal therebetween.

The container 44 (with the powder mixture 42 and any desired displacements 50 contained therein) may be provided within a pressure chamber 52. A removable cover 54 may be used to provide access to an interior of the pressure chamber 52. A fluid (which may be substantially incompressible) such as, for example, water, oil, or gas (such as, for example, air or nitrogen) is pumped into the pressure chamber 52 through an opening 56 at high pressures using a pump (not shown). The high pressure of the fluid causes the walls of the deformable member 46 to deform. The fluid pressure may be transmitted substantially uniformly to the powder mixture 42. The pressure within the pressure chamber 52 during isostatic pressing may be greater than about 35 megapascals (about 5,000 pounds per square inch). More particularly, the pressure within the pressure chamber 52 during isostatic pressing may be greater than about 138 megapascals (20,000 pounds per square inch). In alternative methods, a vacuum may be provided within the container 44 and a pressure greater than about 0.1 megapascals (about 15 pounds per square inch) may be applied to exterior surfaces of the container 44 (by, for example, the atmosphere) to compact the powder mixture 42. Isostatic pressing of the powder mixture 42 may form a green powder component or green bit body 58 shown in FIG. 3B, which can be removed from the pressure chamber 52 and container 44 after pressing.

In an additional method of pressing the powder mixture 42 to form the green bit body 58 shown in FIG. 3B, the powder mixture 42 may be uniaxially pressed in a mold or die (not shown) using a mechanically or hydraulically actuated plunger (not shown) by methods that are known to those of ordinary skill in the art of powder processing.

The green bit body 58, shown in FIG. 3B, may include a plurality of particles (hard particles and particles of matrix material) held together by a binder material provided in the powder mixture 42 (FIG. 3A), as previously described. Certain structural features may be machined in the green bit body 58 using conventional machining techniques including, for example, turning techniques, milling techniques, and drilling techniques. Hand held tools also may be used to manually form or shape features in or on the green bit body 58. By way of example and not limitation, blades 20, junk slots 22 (FIG. 1), and a face 26 may be machined or otherwise formed in the green bit body 58 to form a shaped green bit body 60, shown in FIG. 3C.

The shaped green bit body 60, shown in FIG. 3C, may be at least partially sintered to provide a brown bit body 62, shown in FIG. 3D, which has less than a desired final density. Prior to partially sintering the shaped green bit body 60, the shaped green bit body 60 may be subjected to moderately elevated temperatures and pressures to burn off or remove any fugitive additives that may have been included in the powder mixture 42 (FIG. 3A), as previously described. Furthermore, the shaped green bit body 60 may be subjected to a suitable atmosphere tailored to aid in the removal of such additives. Such atmospheres may include, for example, hydrogen gas at temperatures of about 500° C.

The brown bit body 62 may be substantially machinable due to the remaining porosity therein. Certain structural features may be machined in the brown bit body 62 using conventional machining techniques including, for example, turning techniques, milling techniques, and drilling techniques. Hand held tools also may be used to manually form or shape features in or on the brown bit body 62. Tools that include superhard coatings or inserts may be used to facilitate machining of the brown bit body 62. Additionally, material coatings may be applied to surfaces of the brown bit body 62 that are to be machined to reduce chipping of the brown bit body 62. Such coatings may include a fixative or other polymer material.

In some embodiments, a majority of the bit body 12, or major structure of the bit body 12, may be formed as a green or brown major structure that may not include the material that subsequently forms the one or more insert support regions 32. Rather, receptacles may be formed, such as by machining, in either the green major structure, or the brown major structure, to receive one or more separately formed insert support structures. The one or more insert support structures may then be positioned within the receptacles. Upon subsequent sintering, the green or the brown major structure and the one or more separately formed insert support structures may join to form an integral bit body 12, wherein the one or more insert support structures form each insert support region 32 of the bit body 12.

In additional embodiments, the green bit body 58 may be formed with pressed powder mixture 42 regions that may be sintered to form each insert support region 32 of the bit body 12.

By way of example and not limitation, internal fluid passageways 24, pockets 30, and buttresses 34 (FIG. 1) may be machined or otherwise formed in the brown bit body 62 to form a shaped brown bit body 64 shown in FIG. 3E. Optionally, if the drill bit 10 is to include a plurality of inserts 36 integrally formed with the bit body 12, the inserts 36 may be positioned within the pockets 30 formed in the insert support regions 32 of the brown bit body 62. Upon subsequent sintering of the brown bit body 62, the inserts 36 may become secured to and integrally formed with the insert support regions 32 of the bit body 12.

The shaped brown bit body 64, shown in FIG. 3E, may then be fully sintered to a desired final density to provide the previously described bit body 12 shown in FIG. 1. As sintering involves densification and removal of porosity within a structure, the structure being sintered will shrink during the sintering process. A structure may experience linear shrinkage of between about 10% and about 20% during sintering from a green state to a desired final density. As a result, dimensional shrinkage must be considered and accounted for when designing tooling (molds, dies, etc.) or machining features in structures that are less than fully sintered.

During all sintering and partial sintering processes, refractory structures or displacements (not shown) may be used to support at least portions of the bit body during the sintering process to maintain desired shapes and dimensions during the densification process. Such displacements may be used, for example, to maintain consistency in the size and geometry of the pockets 30 and the internal fluid passageways 24 during the sintering process. Such refractory structures may be formed from, for example, graphite, silica, or alumina. The use of alumina displacements instead of graphite displacements may be desirable as alumina may be relatively less reactive than graphite, thereby minimizing atomic diffusion during sintering. Additionally, coatings such as alumina, boron nitride, aluminum nitride, or other commercially available materials may be applied to the refractory structures to prevent carbon or other atoms in the refractory structures from diffusing into the bit body during densification.

In additional embodiments, the green bit body 58, shown in FIG. 3B, may be partially sintered to form a brown bit body without prior machining, and all necessary machining may be performed on the brown bit body prior to fully sintering the brown bit body to a desired final density. Alternatively, all necessary machining may be performed on the green bit body 58, shown in FIG. 3B, which may then be fully sintered to a desired final density.

The sintering processes described herein may include conventional sintering in a vacuum furnace, sintering in a vacuum furnace followed by a conventional hot isostatic pressing process, and sintering immediately followed by isostatic pressing at temperatures near the sintering temperature (often referred to as sinter-HIP). Furthermore, the sintering processes described herein may include subliquidus phase sintering. In other words, the sintering processes may be conducted at temperatures proximate to but below the liquidus line of the phase diagram for the matrix material. For example, the sintering processes described herein may be conducted using a number of different methods known in the art, such as the Rapid Omnidirectional Compaction (ROC) process, the CERACON® process, hot isostatic pressing (HIP), or adaptations of such processes.

Broadly, and by way of example only, sintering a green powder compact using the ROC process involves presintering the green powder compact at a relatively low temperature to only a sufficient degree to develop sufficient strength to permit handling of the powder compact. The resulting brown structure is wrapped in a material such as graphite foil to seal the brown structure. The wrapped brown structure is placed in a container, which is filled with particles of a ceramic, polymer, or glass material having a substantially lower melting point than that of the matrix material in the brown structure. The container is heated to the desired sintering temperature, which is above the melting temperature of the particles of a ceramic, polymer, or glass material, but below the liquidus temperature of the matrix material in the brown structure. The heated container with the molten ceramic, polymer, or glass material (and the brown structure immersed therein) is placed in a mechanical or hydraulic press, such as a forging press, that is used to apply pressure to the molten ceramic or polymer material. Isostatic pressures within the molten ceramic, polymer, or glass material facilitate consolidation and sintering of the brown structure at the elevated temperatures within the container. The molten ceramic, polymer, or glass material acts to transmit the pressure and heat to the brown structure. In this manner, the molten ceramic, polymer, or glass acts as a pressure transmission medium through which pressure is applied to the structure during sintering. Subsequent to the release of pressure and cooling, the sintered structure is then removed from the ceramic, polymer, or glass material. A more detailed explanation of the ROC process and suitable equipment for the practice thereof is provided by U.S. Pat. Nos. 4,094,709, 4,233,720, 4,341,557, 4,526,748, 4,547,337, 4,562,990, 4,596,694, 4,597,730, 4,656,002 4,744,943 and 5,232,522, the disclosure of each of which patents is incorporated in its entirety herein by reference.

The CERACON® process, which is similar to the aforementioned ROC process, may also be adapted for use in the present invention to fully sinter brown structures to a final density. In the CERACON® process, the brown structure is coated with a ceramic coating such as alumina, zirconium oxide, or chrome oxide. Other similar, hard, generally inert, protective, removable coatings may also be used. The coated brown structure is fully consolidated by transmitting at least substantially isostatic pressure to the coated brown structure using ceramic particles instead of a fluid media as in the ROC process. A more detailed explanation of the CERACON® process is provided by U.S. Pat. No. 4,499,048, the disclosure of which patent is incorporated in its entirety herein by reference.

Furthermore, in embodiments in which tungsten carbide is used in a particle-matrix composite bit body, the sintering processes described herein also may include a carbon control cycle tailored to improve the stoichiometry of the tungsten carbide material. By way of example and not limitation, if the tungsten carbide material includes WC, the sintering processes described herein may include subjecting the tungsten carbide material to a gaseous mixture including hydrogen and methane at elevated temperatures. For example, the tungsten carbide material may be subjected to a flow of gases including hydrogen and methane at a temperature of about 1,000° C.

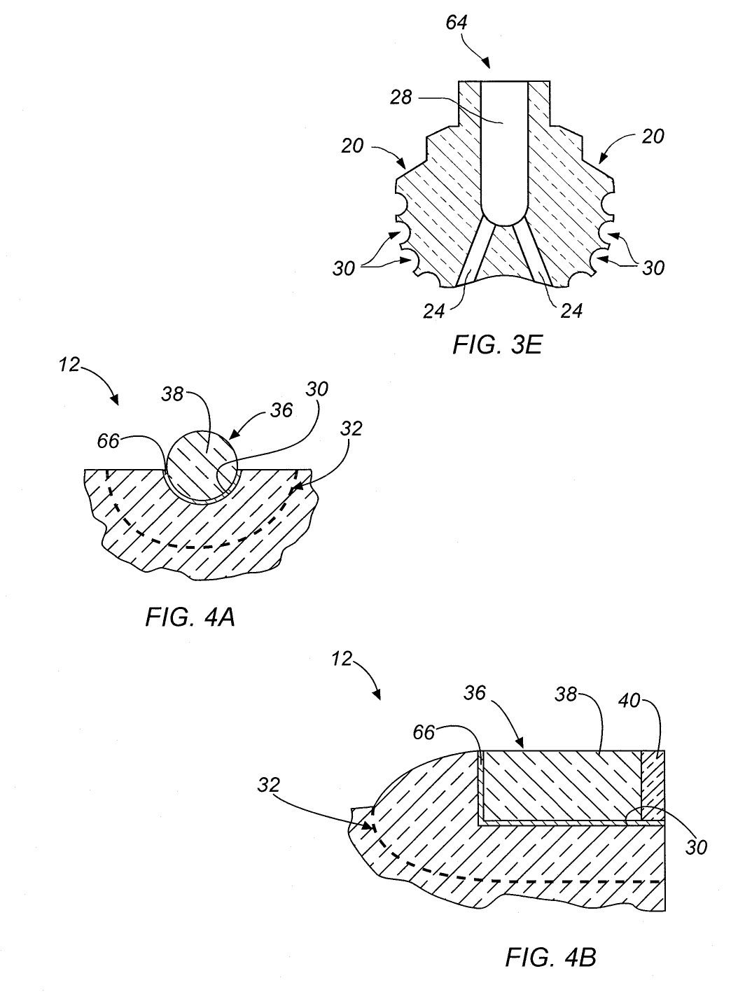

FIGS. 4A and 4B show cross-sectional detail views of an insert 36 and an insert support region 32 of a bit body 12. The insert support region 32 is indicated by a dashed line. While the insert support region 32 indicated by the dashed line in FIGS. 4A and 4B is illustrative of one embodiment, the insert support region 32 may be formed in any number of shapes and sizes, and is not limited to the configuration shown. Additionally, in some embodiments, the insert support region 32 may not be distinguishable from the majority of the bit body 12. In yet additional embodiments, there may be no discrete boundary between the insert support region 32 and the majority of the bit body 12. For example, there may be a gradient of material compositions within the bit body 12.

As shown in FIGS. 4A and 4B, if the inserts 36 are secured to insert support regions 32 of the bit body 12 after the bit body 12 is fully sintered, a bonding material 66 may be used to secure the insert body 38 of the insert 36 to an insert support region 32 of the bit body 12. If a bonding material 66 is used, a bonding material 66 with relatively high thermal conductivity may be desirable, as it may promote efficient heat transfer from the insert 36 to the insert support region 32 of the bit body 12. For example, the bonding material 66 may be a brazing material comprising one or more metals with relatively high thermal conductivity, such as gold, copper, and silver. The brazing material may be heated and flowed between the insert support region 32 of the bit body 12 and the insert 36 and then allowed to cool and harden.

While the present invention is described herein in relation to embodiments of earth-boring rotary drill bits that include fixed cutters, other types of earth-boring drilling tools such as, for example, core bits, eccentric bits, bicenter bits, reamers, mills, drag bits, roller cone bits, and other such structures known in the art may embody teachings of the present invention and may be formed by methods according to embodiments of the present invention. Accordingly, the teen “bit body” as used herein includes and encompasses bodies of earth-boring tools.

While the present invention has been described herein with respect to certain embodiments, those of ordinary skill in the art will recognize and appreciate that it is not so limited. Rather, many additions, deletions and modifications to the embodiments may be made without departing from the scope of the invention as hereinafter claimed, including legal equivalents. In addition, features from one embodiment may be combined with features of another embodiment while still being encompassed within the scope of the invention as contemplated by the inventors. Further, the invention has utility in drill bits and core bits having different and various bit profiles, as well as insert types.

1. An earth-boring tool, comprising:
a body comprising at least one insert support region; and
at least one insert comprising an insert body secured to the at least one insert support region; and
wherein the at least one insert support region of the body has a thermal conductivity within a range of about 50% to about 150% of a thermal conductivity of the insert body of the at least one insert.

2. The earth-boring tool of claim 1, wherein the at least one insert support region of the body has a thermal conductivity within a range of about 75% to about 125% of the thermal conductivity of the insert body of the at least one insert.

3. The earth-boring tool of claim 2, wherein the at least one insert support region of the body has a thermal conductivity within a range of about 85% to about 115% of the thermal conductivity of the insert body of the at least one insert.

4. The earth-boring tool of claim 3, wherein the at least one insert support region of the body has a thermal conductivity within a range of about 95% to about 105% of the thermal conductivity of the insert body of the at least one insert.

5. The earth-boring tool of claim 4, wherein the at least one insert support region of the body has a thermal conductivity that is substantially the same as the thermal conductivity of the insert body of the at least one insert.

6. The earth-boring tool of claim 1, wherein the at least one insert support region of the body has a thermal conductivity greater than the thermal conductivity of a majority of the body.

7. The earth-boring tool of claim 1, wherein the at least one insert support region of the body has the same material composition as a majority of the body.

8. The earth-boring tool of claim 1, wherein the at least one insert support region of the body is formed of a different material composition than a majority of the body.

9. The earth-boring tool of claim 1, wherein the at least one insert comprises a cutter.

10. The earth-boring tool of claim 1, wherein the at least one insert support region has a thermal conductivity greater than about 60 W/mK.

11. The earth-boring tool of claim 10, wherein the at least one insert support region has a thermal conductivity greater than about 80 W/mK.

12. The earth-boring tool of claim 11, wherein the at least one insert support region has a thermal conductivity greater than about 100 W/mK.

13. The earth-boring tool of claim 12, wherein the at least one insert support region has a thermal conductivity greater than about 110 W/mK.

14. An earth-boring tool, comprising:
at least one insert comprising a particle-matrix composite insert body having a thermal conductivity greater than about 100 W/mK, and
a body having at least one particle-matrix composite insert support region formed therein, the at least one particle-matrix composite insert support region having a thermal conductivity within a range of about 50% to about 150% of the thermal conductivity of the particle-matrix composite insert body of the at least one insert; and
wherein the particle-matrix composite insert body of the at least one insert is secured to the at least one particle-matrix composite insert support region.

15. The earth-boring tool of claim 14, wherein the at least one particle-matrix composite insert support region of the body has a thermal conductivity within a range of about 75% to about 125% of the thermal conductivity of the particle-matrix composite insert body of the at least one insert.

16. The earth-boring tool of claim 15, wherein the insert body of the at least one particle-matrix composite insert has a thermal conductivity greater than about 110 W/mK.

17. The earth-boring tool of claim 16, wherein the at least one particle-matrix composite insert support region of the body has a thermal conductivity within a range of about 85% to about 115% of the thermal conductivity of the particle-matrix composite insert body of the at least one insert.

18. The earth-boring tool of claim 17, wherein the at least one particle-matrix composite insert support region of the body has a thermal conductivity within a range of about 95% to about 105% of the thermal conductivity of the particle-matrix composite insert body.

19. The earth-boring tool of claim 18, wherein the at least one particle-matrix composite insert support region of the body has a thermal conductivity that is substantially the same as the thermal conductivity of the particle-matrix composite insert body.

20. The earth-boring tool of claim 14, wherein the at least one particle-matrix composite insert support region of the body has a thermal conductivity greater than a thermal conductivity of a majority of the body.

21. A method of forming an earth-boring tool, the method comprising:
forming a body having at least one insert support region with a thermal conductivity within a range of about 50% to about 150% of the thermal conductivity of an insert body of at least one insert by sintering a powder mixture; and
securing the insert body of the at least one insert to the at least one insert support region of the body.

22. The method of claim 21, wherein forming a body having at least one insert support region with a thermal conductivity within a range of about 50% to about 150% of the thermal conductivity of an insert body of at least one insert by sintering a powder mixture comprises forming a body having at least one insert support region with a thermal conductivity within a range of about 75% to about 125% of the thermal conductivity of an insert body of at least one insert by sintering a powder mixture.

23. The method of claim 21, wherein securing the insert body to at least one insert support region of a body comprises brazing the insert body to the at least one insert support region with a brazing material comprising at least one of gold, copper, and silver.

24. The method of claim 21, wherein securing the insert body to at least one insert support region of a body comprises integrally forming the insert body to the at least one insert support region of the body by sintering the body while the at least one insert is positioned within at least one pocket formed in the insert support region of the body.

25. An earth-boring tool, comprising:
a body comprising at least one insert support region; and
at least one insert comprising an insert body secured to the at least one insert support region; and
wherein the at least one insert support region of the body has a thermal conductivity that is greater than the thermal conductivity of the insert body of the at least one insert.

26. An earth-boring tool, comprising a body having at least one insert support region having a thermal conductivity greater than a thermal conductivity of a majority of the body.
